(19) United States
(12) Patent Application Publication
(10) Pub. No.: US 2009/0141917 A1
(43) Pub. Date: Jun. 4, 2009

(54) Speaker cone protection arrangement

(76) Inventors: Mark Miller, Parma, OH (US); Robert Miller, Parma, OH (US); Joseph Birli, Munson, OH (US)

Correspondence Address: Fay Sharpe LLP, 1228 Euclid Avenue, 5th Floor, The Halle Building, Cleveland, OH, 44115, US

(21) Appl. No.: 11/999,201

(22) Filed: Dec. 4, 2007

(51) Int. Cl. H04R 25/00

(52) U.S. Cl. 381/189

(57) ABSTRACT

An arrangement used in a speaker designed to restrict movement of at least a portion of the speaker cone, to inhibit the speaker cone from deforming, completely flipping inside out and/or to inhibit sticking of the speaker cone to a frame of the speaker. In one arrangement, there is provided a speaker insert that is designed to be inserted at least partially between the frame and the cone of a speaker. The speaker insert includes a body having a front face and a rear face, a frame opening positioned at least closely adjacent to a center region of the body, and a plurality of gas openings spaced from the primary opening and spaced from a periphery edge of the body. In another and/or additional arrangement, the speaker includes a modified speaker frame.

The present invention is directed to speakers, and particularly to an arrangement in a speaker that restricts movement of at least a portion of the speaker cone, inhibits the speaker cone from partially or fully flipping inside-out, and/or inhibits sticking of the speaker cone to one or more components of the speaker when the speaker is exposed to a vacuum and/or rapid temperature changes.

### BACKGROUND OF THE INVENTION

Certain types of speakers are subjected to extreme testing to establish that such speakers will operate in hostile environments. Speakers that are used on emergency equipment, such as firefighting equipment, can be subjected to extremely high temperatures and/or be subjected to large temperature changes during use. These types of speakers are commonly subjected to various types of heat immersion testing to ensure the operability of such speakers in such hostile environments.

The heat immersion test, as specified by the NFPA (National Fire Protection Association), requires a device to be placed in a 350° F. oven for 15 minutes. After the 15 minutes, the device is placed in 1.5 meters of water within 2 minutes of being removed from the oven. The device remains submerged at this depth for 15 minutes, and then removed and wiped dry. This process is repeated 5 more times. After these 6 testing cycles, the device is tested and must operate “in accordance with the manufacturers instructions.”

When a speaker is exposed to large temperature changes in such short periods of time, a vacuum is commonly formed within the housing. These large and rapid temperature changes are simulated during a heat immersion test. The speaker cone of the speaker is generally vacuum formed to the frame due to the large temperature changes during testing. The exposure of the speaker cone to such a vacuum induces a large amount of stress on the speaker cone, thereby resulting in the deformation of the speaker cone. During heat immersion testing, the speaker cone can at least partially flip inside-out. The deformation of the speaker cone can result in permanent deformation and/or result in damage to the speaker cone, which permanent deformation and/or speaker cone damage can adversely affect the sound output of the speaker.

In addition to problems relating to permanent deformation and/or speaker cone damage, the inside or underside surface of the speaker cone can potentially adhere to one or more internal surfaces of the speaker, thereby preventing the speaker cone from reverting back to its original shape after the heat immersion test is completed. An adhesive is commonly used to adhere a wire to the underside of the speaker cone. This wire is typically connected to the speaker coil in the speaker. During the heat immersion test, this adhesive on the inner surface or underside of the speaker cone can soften and/or melt. When the speaker cone is subjected to a vacuum which can cause the speaker cone to become vacuum formed to the frame of the speaker, the adhesive on the inner surface or underside of the speaker cone can cause the speaker cone to stick to the frame, thereby preventing the speaker cone form reforming into its original shape. Such sticking of the inner surface or underside of the speaker cone to the frame of the speaker can drastically affect the quality of the sound output of the speaker. The speaker cone can also or alternatively stick to the speaker frame by cohesion when the speaker cone is exposed to a vacuum.

In view of the current state of the art of speakers, there is a need for a speaker that minimizes or prevents speaker cone deformation during heat immersion testing of the speaker and/or exposure of the speaker cone to a vacuum, and/or inhibits or prevents the inner surface or underside of the speaker cone from sticking to an inside surface of the speaker during heat immersion testing of the speaker and/or exposure of the speaker cone to a vacuum.

### SUMMARY OF THE INVENTION

The present invention is directed to a speaker that overcomes the past limitations of speakers regarding deformation and/or sticking problems associated with a speaker cone during heat immersion testing of the speaker. The present invention is directed to a speaker that is designed to a) restrict movement of at least a portion of the speaker cone during and/or after a heat immersion process, and/or when the speaker cone is exposed to a vacuum, b) inhibit one or more portions of the speaker cone from at least partially flipping inside-out during and/or after a heat immersion process, and/or when the speaker cone is exposed to a vacuum, and/or c) inhibit the speaker cone from sticking to one or more components of the speaker during and/or after a heat immersion process, and/or when the speaker cone is exposed to a vacuum.

In one non-limiting aspect of the present invention, there is provided a structural arrangement that is designed to inhibit or prevent one or more portions of the speaker cone from flipping inside-out. One or more portions of a speaker cone of a speaker generally have a concave shape portion; however, the speaker cone can have other or additional shapes. In one non-limiting arrangement of a speaker cone, the speaker cone includes one or more regions that have a concave profile. In another non-limiting arrangement of a speaker cone, the central portion of the speaker cone has a generally flat or planar profile and one or more regions about the central portion of the speaker cone that have a generally concave profile. As can be appreciated, the speaker cone can have many other profiles. Indeed, the present invention can be used in any speaker wherein one or more portions of a speaker cone can potentially partially or fully flip inside out. The edges of the speaker cone are generally connected to the speaker frame so as to maintain the speaker cone on the speaker frame. Many different arrangements can be used to secure the speaker cone to the speaker frame. For example, an adhesive and/or clamp arrangement is commonly used to secure the edge of the speaker cone to the speaker frame; however, it will be appreciated that other or alternative arrangements can be used to secure the speaker cone to the speaker frame. The central portion or region of the inner surface or underside of the speaker cone is generally spaced from the speaker frame and/or from a voice or speaker coil of the speaker. This spacing enables the speaker cone to vibrate and produce the desired sound quality from the speaker. It is common for one end of a wire to be connected to the inner surface or underside of the speaker cone by use of an adhesive and the other end of the wire to be connected to the voice coil or speaker coil. Various types of speakers are used for different types of applications (e.g., stereo equipment, computers, TVs, radios, intercoms, walkie talkies, two way radios, etc.). Speakers that are used in emergency equipment (e.g., fire fighter equipment, first responder equipment, etc.) can be subjected to extreme conditions (e.g., very hot conditions, very cold conditions, rapid temperature changing conditions, etc.). In such extreme environments, it is important to maintain the operability of the communication equipment. In certain situations, it can be common for the speaker to be exposed to high temperatures and suddenly exposed to low temperatures. This can occur with speakers in fire fighting equipment wherein a fire fighter is fighting a fire and the surrounding environment is extremely hot, but suddenly the fire fighter is sprayed with water which causes the speaker to be suddenly cooled. As can be appreciated, there are other instances which exist wherein a speaker can be exposed to a hot temperature and then quickly or suddenly exposed to a cooler temperature. The change in temperature from a hot to a cold temperature can result in a vacuum being temporarily formed between the speaker frame and the inner surface or underside of the speaker cone. This vacuum can cause the speaker cone to partially collapse onto the speaker frame and/or cause the one or more concave portions of the speaker cone to partially or fully invert from a concave shape to a convex shape. This deformation of the speaker cone can partially or fully disrupt the operation of the speaker. The deformation of the speaker cone can also or alternatively cause damage to the speaker cone, which in turn can cause a reduction in sound quality of the speaker or may cause the speaker to stop functioning. As such, the deformation of the speaker cone can cause temporary or permanent disruption of communication and/or impair communication via the speaker. The structural arrangement of the present invention is designed to inhibit or prevent a) the speaker cone from partially collapsing onto the speaker frame and/or from partially or fully inverting from a concave shape to a convex shape, and/or b) cause damage to the speaker cone. The present invention is specifically directed to two structural arrangements that can be used individually or can be used in combination with one another to achieve the objects set forth above. One arrangement is the use of a speaker insert that is at least partially positioned between the speaker frame and the inner surface or underside of the speaker cone. Another arrangement is the modification of the shape of the speaker frame. As can be appreciated, other or additional arrangements can be used to achieve the objectives set forth above.

In another and/or alternative non-limiting aspect of the invention, there is provided a speaker insert that is designed to be positioned at least partially between the inner surface or underside of the speaker cone and one or more internal components of a speaker to inhibit or prevent one or more portions of the speaker cone from at least partially collapsing and/or from at least partially flipping inside-out. As such, one non-limiting function of the speaker insert is to reduce the downward movement or movement of the speaker cone toward the speaker frame when the speaker cone is exposed to a vacuum (e.g., during a heat immersion test, etc.) and to at least partially support the speaker cone in a profile that does not cause the speaker cone to overly deform when the speaker cone is subjected to pressure and heat. As such, the speaker insert reduces the stress and deformation the speaker cone experiences when subjected to a vacuum. In one non-limiting embodiment of the invention, the speaker insert is designed to be positioned between the inner surface of the frame of the speaker and the inner surface or underside of the speaker cone such that the speaker insert is positioned under at least a portion of the speaker cone that has a concave profile; however, it can be appreciated that the speaker insert can be positioned in other or additional locations. The speaker insert can have a variety of shapes so as to fit the variety of differently shaped speaker frames. In one non-limiting aspect of this embodiment, the speaker insert is sized and shaped such that a majority of the outer or peripheral edge of the speaker insert, when properly inserted in the speaker, does not extend beyond the outer peripheral edge of the speaker frame; however, this is not required. In one non-limiting configuration, the outer peripheral edge of the speaker insert defines a cross-sectional area that is less than a cross-sectional area that is defined by the outer peripheral edge of the speaker frame. In another and/or alternative non-limiting configuration, the speaker insert is shaped and sized to fit within the speaker frame. In still another and/or alternative non-limiting aspect of this embodiment, the speaker insert is sized and shaped such that at least a portion of the speaker cone does not contact the speaker insert when the speaker is operating in a constant ambient temperature (e.g., 70-100° F.) and ambient pressure (e.g., 14.7 psi (absolute)). The speaker insert is thus designed to not interfere with the normal operation of the speaker cone. In one non-limiting arrangement, the speaker insert is sized and shaped such that at least about 10% of the inner surface or underside of the speaker cone does not contact the speaker insert when the speaker is operating in a constant ambient temperature and ambient pressure. In still another non-limiting arrangement, the speaker insert is sized and shaped such that at least about 25% of the inner surface or underside of the speaker cone does not contact the speaker insert when the speaker is operating in a constant ambient temperature and ambient pressure. In still another non-limiting arrangement, the speaker insert is sized and shaped such that more than 50% of the inner surface or underside of the speaker cone does not contact the speaker insert when the speaker is operating in a constant ambient temperature and ambient pressure. In yet another non-limiting arrangement, the speaker insert is sized and shaped such that at least about 75% of the inner surface or underside of the speaker cone does not contact the speaker insert when the speaker is operating in a constant ambient temperature and ambient pressure. In still yet another non-limiting arrangement, the speaker insert is sized and shaped such that 100% of the inner surface or underside of the speaker cone does not contact the speaker insert when the speaker is operating in a constant ambient temperature and ambient pressure.

In still another and/or alternative non-limiting aspect of the invention, there is provided a speaker insert that is designed to be positioned at least partially between the inner surface or underside of the speaker cone and one or more internal components of a speaker to inhibit or prevent one or more portions of the speaker cone from at least partially collapsing and/or from at least partially flipping inside-out, and the speaker insert includes a thickness profile and/or an upper surface profile designed to accommodate the shape of the inner surface or underside profile of the speaker cone. In one non-limiting embodiment of the invention, the thickness of the speaker insert is not uniform. In one non-limiting aspect of this embodiment, the outer edge or region of the speaker insert has a thickness that is greater than the thickness of an inner edge or region of the speaker insert. In one non-limiting arrangement, the thickness of the outer edge or region of the speaker insert is at least about 10% greater than the thickness of an inner edge or region of the speaker insert. In another non-limiting arrangement, the thickness of the outer edge or region of the speaker insert is at least about 25% greater than the thickness of an inner edge or region of the speaker insert. In still another non-limiting arrangement, the thickness of the outer edge or region of the speaker insert is at least about 50% greater than the thickness of an inner edge or region of the speaker insert. In yet another non-limiting arrangement, the thickness of the outer edge or region of the speaker insert is at least about 100% greater than the thickness of an inner edge or region of the speaker insert. In still yet another non-limiting arrangement, the thickness of the outer edge or region of the speaker insert is at least about 125% greater than the thickness of an inner edge or region of the speaker insert. In another and/or alternative non-limiting embodiment of the invention, the upper surface profile of the speaker insert is not flat or planar. In one non-limiting aspect of this embodiment, at least a portion of the top surface of the speaker insert slopes downwardly between the outer edge or outer peripheral portion of the speaker insert and the center of the speaker insert. In one non-limiting design, at least a portion of the top surface of the speaker insert slopes downwardly at an average angle of at least about 5° between the outer edge or outer peripheral portion of the speaker insert and the center of the speaker insert. In another non-limiting design, at least a portion of the top surface of the speaker insert slopes downwardly at an average angle of at least about 10° between the outer edge or outer peripheral portion of the speaker insert than the center of the speaker insert. In another and/or alternative non-limiting aspect of this embodiment, the top surface of the speaker insert has a generally convex profile; however, this is not required. The convex shape of the upper surface profile of the speaker insert is roughly the same as the inner surface or underside surface profile of the speaker cone, but offset from the inner surface or underside of the speaker cone to provide clearance so that the speaker cone can move its normal stroke without contacting the spacer insert; however, this is not required. In still another and/or alternative non-limiting aspect of this embodiment, the bottom of the speaker insert has a profile that is generally flat or planar so as to match the inside surface of the speaker frame; however, this is not required. In still another and/or alternative non-limiting embodiment of the invention, the thickness of the speaker insert is thin enough in various regions of the speaker insert to allow room for the speaker cone to deflect in normal operation without contacting the speaker insert, and yet thick enough to support the speaker cone to inhibit or prevent one or more portions of the speaker cone from at least partially collapsing and/or from at least partially flipping inside-out when the speaker cone is exposed to a vacuum (e.g., heat immersion testing, exposure to sudden temperature changes etc.). In yet another and/or alternative non-limiting embodiment of the invention, the speaker insert is thicker on the outer edge or peripheral edge than the regions closer to the center of the speaker insert; however, this is not required. This thickness profile for the speaker insert can be used to account for the fact that in many speakers, the speaker cone of the speaker is farther away from the frame on the outer edge of the speaker than in the middle of the speaker. In one non-limiting aspect of this embodiment, the top surface of the speaker insert, when inserted in the speaker, is maintained at about an equal distance between the speaker cone and the speaker insert throughout a majority of the space between the speaker insert and the speaker cone; however, this is not required.

In yet another and/or alternative non-limiting aspect of the invention, there is provided a speaker insert that is designed to be positioned at least partially between the inner surface or underside of the speaker cone and one or more internal components of a speaker to inhibit or prevent one or more portions of the speaker cone from at least partially collapsing and/or from at least partially flipping inside-out, which speaker insert includes a plurality of openings; however, this is not required. In one non-limiting embodiment of the invention, the speaker insert includes at least one gas opening to enable a gas (e.g., air, etc.) to flow into and/or out of the space between the speaker insert and the inner or underside surface of the speaker cone. The flow of air into the space between the speaker insert and the inner or underside surface of the speaker cone allows the speaker cone to vibrate during operation of the speaker. The size and number of gas openings are generally selected to achieve a good frequency response for the speaker and/or to create low distortion; however, this is not required. The size and number of gas holes in the speaker insert are generally selected to prevent the volume or space between the cone and speaker frame from becoming a sealed volume; however, this is not required. By allowing air to freely or substantially freely pass between the back of the speaker and into the volume between the speaker cone and the speaker frame, the speaker is able to operate more efficiently; however, this is not required. In one non-limiting arrangement, the speaker insert includes a plurality of gas openings. The number of gas openings in the speaker insert can be the same number of openings in the speaker frame; however, this is not required. The size of the gas openings in the speaker insert can be the same size as the openings in the speaker frame; however, this is not required. The speaker insert can be designed such that one or a plurality of gas openings are partially or fully aligned with one or more openings on the speaker frame; however, this is not required. Three or more gas openings can be spaced at equal distances from one another; however, this is not required. A plurality of gas openings can be spaced at an equal distance from the outer or peripheral edge of the speaker insert; however, this is not required. A plurality of the gas openings can have the same shape and/or size; however, this is not required. A plurality of the gas openings can have the same cross-sectional shape along the length of the gas openings; however, this is not required. The cross-sectional shape along the length of one or more gas openings can be constant or vary. In another and/or alternative non-limiting embodiment of the invention, the speaker insert includes a frame opening that is designed to not fully cover the speaker coil and/or cavity in the speaker frame that contains the speaker coil. The frame opening in the speaker insert is generally selected so as to have a size that is sufficient to not impair or substantially impair the sound quality of the speaker; however, this is not required. Generally, the frame opening is positioned in the central region of the speaker insert; however, this is not required. Generally, the frame opening overlies less than about 75% of the cavity in the speaker frame that contains the speaker coil, typically less than about 50% of the cavity in the speaker frame that contains the speaker coil, more typically less than about 25% of the cavity in the speaker frame that contains the speaker coil, and even more typically less than about 10% of the cavity in the speaker frame that contains the speaker coil. In one non-limiting arrangement, the frame opening, when positioned in the speaker, is positioned about a cavity in the speaker frame that contains the speaker coil and overlies 0-2% of the cavity in the speaker frame that contains the speaker coil. In one non-limiting aspect of this embodiment, the cross-sectional area of the frame opening is greater than one or more gas openings in the speaker insert. In another non-limiting aspect of this embodiment, the cross-sectional area of the frame opening is greater than all of the gas openings in the speaker insert. In still another and/or alternative non-limiting aspect of this embodiment, the size of the cross-sectional area of the frame opening is at least about 10% greater than the average size of the gas openings in the speaker insert. In yet another and/or alternative non-limiting aspect of this embodiment, the size of the cross-sectional area of the frame opening is at least about 25% greater than the average size of the gas openings in the speaker insert. In still yet another and/or alternative non-limiting aspect of this embodiment, the size of the cross-sectional area of the frame opening is at least about 50% greater than the average size of the gas openings in the speaker insert. In another and/or alternative non-limiting aspect of this embodiment, the size of the cross-sectional area of the frame opening is at least about 100% greater than the average size of the gas openings in the speaker insert. In still another and/or alternative non-limiting aspect of this embodiment, the size of the cross-sectional area of the frame opening is at least about 150% greater than the average size of the gas openings in the speaker insert. In yet another and/or alternative non-limiting aspect of this embodiment, the size of the cross-sectional area of the frame opening is at least about 200% greater than the average size of the gas openings in the speaker insert.

In still yet another and/or alternative non-limiting aspect of the invention, there is provided a speaker insert that is designed to be positioned at least partially between the inner surface or underside of the speaker cone and one or more internal components of a speaker to inhibit or prevent one or more portions of the speaker cone from at least partially collapsing and/or from at least partially flipping inside-out, which speaker insert includes a connection arrangement designed to secure the speaker insert to the frame of the speaker. The speaker insert can be connected to the speaker frame in many different ways (e.g., adhesive, clamp, rivet, screw, bolt, etc.). In one non-limiting embodiment of the invention, the speaker insert includes one or more connection legs that are used to secure the speaker inserted to the frame. In one non-limiting aspect of this embodiment, one or more of the speaker legs are positioned on the side or peripheral edge of the speaker insert and/or on the back side or underside of the speaker insert. In another and/or alternative non-limiting aspect of this embodiment, one or more of the speaker legs are designed to be connected to one or more openings in the speaker frame of the speaker. It is common that a speaker frame includes one or more openings to allow air to flow into and out of the speaker. The one or more speaker legs can be sized and designed to engage with and/or be at least partially inserted into and/or through one or more openings in the speaker frame; however, this is not required. In one non-limiting design, the speaker insert includes a plurality of legs that are generally evenly spaced around the center axis of the speaker insert to facilitate in generally even support and/or retention of the speaker insert in and/or to the speaker frame; however, this is not required. In another and/or alternative design, one or more speaker legs include a notch, flange and/or other type of connection structure that is used to secure the speaker leg to an opening in the speaker frame when the speaker leg is at least partially inserted into the opening in the speaker frame; however, this is not required. As can be appreciated, the one or more speaker legs on the speaker insert can be secured to the speaker frame in other or additional ways (e.g., adhesive, clamp, friction connection, screws, barbs, retainers etc.). The mounting arrangement used for the speaker insert generally holds the speaker insert firmly against and/or in the speaker frame so as to inhibit or prevent the speaker inset from vibrating and/or resonating, which vibration and/or resonation can cause distortion; however, this is not required.

In another and/or alternative non-limiting aspect of the invention, there is provided a speaker insert that is designed to be positioned at least partially between the inner surface or underside of the speaker cone and one or more internal components of a speaker to inhibit or prevent one or more portions of the speaker cone from at least partially collapsing and/or from at least partially flipping inside-out, which speaker insert is formed of a durable material. The one or more materials used to form the speaker insert can include, but are not limited, nylon, silicon (e.g., GE LIM 650 Silicone, etc.), plastic, rubber, hard foam, ceramic, composite materials, wood, cast epoxy, and/or metal. In one non-limiting embodiment of the invention, the speaker insert is formed of one or more materials that enable the speaker insert to a) at least partially support the cone when the cone is subjected to vacuum, and/or b) withstand the normal operating environment and/or temperatures of the speaker. As such, the speaker insert is generally formed of one or more materials that will not be easily damaged and/or crushed when at least partially supporting a speaker cone that is subjected to a vacuum; however, this is not required. In addition, the speaker insert is generally formed of one or more materials that will not rapidly degrade or fail when exposed to the normal operating environment and/or temperatures of the speaker; however, this is not required. For example, if the speaker is designed to be used in heated environments (e.g., on fire equipment, withstand heat immersion testing, etc.), the material used to form the insert is generally selected to withstand at least about 200-500° F. for at least a short period of time (i.e., 10-60 seconds); however, this is not required. In another and/or alternative non-limiting embodiment of the invention, the speaker insert is formed of one or more materials that enable the speaker insert to resist sticking to the inner surface or underside of the speaker cone. During a heat immersion test, the speaker is exposed to elevated temperatures. The elevated temperatures can cause adhesives, which are commonly located on the inner surface or underside of the speaker cone, to soften and/or melt. During a heat immersion test, the softened or melted adhesive can come in contact with the speaker frame when the speaker cone is subsequently exposed to a vacuum. The contact of the adhesive on the speaker cone to the speaker frame can result in the speaker cone sticking to the speaker frame. The speaker cone can also or alternatively adhere to the speaker frame simply by cohesion. The sticking of the speaker cone to the speaker frame can significantly impair the operation of the speaker. The speaker insert of the present invention that is positioned at least partially behind the speaker cone limits the amount the speaker cone can collapse when the speaker cone is exposed to a vacuum. The speaker insert can be designed to inhibit or prevent the inner surface or underside of the speaker cone from sticking to one or more portions of the speaker insert and/or the speaker frame; however, this is not required. As such, the speaker insert can be designed to enable the speaker cone to revert back to its original form once a vacuum on the speaker cone has dissipated or has been reduced. In one non-limiting aspect of this embodiment, at least the upper surface of the speaker insert includes and/or is coated with a low stick or non-stick material. The one or more materials that are used to form the speaker insert and/or are coated on the speaker insert can be selected to not promote adhesion, and/or to reduce or eliminate adhesion. Non-limiting examples of a low stick or non-stick material that can be used to at least partially form the upper surface of the speaker insert include silicone rubber, fluoropolymer materials (e.g., Teflon materials, etc.). Non-limiting examples of low stick or non-stick coatings that can be used to at least partially coat the upper surface of the speaker insert include silicone compounds, fluoropolymer coatings (e.g., Teflon coatings, etc.). In one non-limiting speaker insert in accordance with the present invention, the speaker insert is formed of silicone. The silicone speaker insert, when installed between the speaker cone and the speaker frame, inhibits or prevents the speaker cone from over flexing when the speaker insert is exposed to a vacuum (e.g., during heat immersion testing, exposure to sudden temperature changes, etc.), thereby reducing the stress the speaker cone experiences; however, this is not required. The silicone speaker insert also inhibits or prevents the speaker cone from sticking to the speaker insert when the speaker insert is exposed to a vacuum; however, this is not required. The silicone speaker insert can further inhibit or prevent the speaker cone from sticking to the speaker frame when the speaker insert is exposed to a vacuum; however, this is not required. In still another and/or alternative non-limiting embodiment of the invention, the speaker insert is formed of one or more materials that are relatively incompressible, and/or are not susceptible to rattling; however, this is not required. The non or limited compressible material is generally used to limit the amount the speaker cone can continue to flex once the speaker cone contacts the speaker insert; however, this is not required. A material used for the speaker insert that is highly compressible would allow for further flexing of the speaker cone after the speaker cone contacts the speaker insert, which further flexing could result in damage to the speaker cone and/or allow the speaker cone to flip inside-out. The use of a non-rattling material is typically used to reduce movement or vibration of the speaker insert, which movement and/or vibration can cause speaker distortion; however, this is not required.

In still another and/or alternative non-limiting aspect of the invention, there is provided a speaker that includes a speaker frame and/or one or more other internal components of the speaker that are made and/or coated with a material that enables the speaker cone to resist sticking to the speaker frame and/or one or more other internal components of the speaker. As mentioned above, an adhesive that is commonly located on the inner surface or underside of the speaker cone can soften and/or melt during a heat immersion test and/or in a heated environment. The softened or melted adhesive can come in contact with the speaker frame and/or one or more other internal components of the speaker when the speaker cone is subsequently exposed to a vacuum. The contact of the adhesive on the speaker cone to the speaker frame and/or one or more other internal components of the speaker can result in the speaker cone sticking to the speaker frame and/or one or more other internal components of the speaker. The speaker cone can also or alternatively adhere to the speaker frame and/or one or more other internal components of the speaker simply by cohesion. The sticking of the speaker cone to the speaker frame and/or one or more other internal components of the speaker can significantly impair the operation of the speaker. By selecting a material used to form the speaker frame and/or one or more other internal components of the speaker that is a low stick or non-stick material, and/or by coating the speaker frame and/or one or more other internal components of the speaker with a material that is a low stick or non-stick material, the incidence of the speaker cone undesirably sticking to the speaker frame and/or one or more other internal components of the speaker can be reduced or eliminated. Non-limiting examples of low stick or non-stick materials that can be used to form the speaker frame and/or one or more other internal components of the speaker include silicone rubber, fluoropolymer materials (e.g., Teflon materials, etc.) Non-limiting examples of low stick or non-stick coatings that can be at least partially coated on the speaker frame and/or one or more other internal components of the speaker include silicone compounds, fluoropolymer coatings (e.g., Teflon coatings, etc.). In one non-limiting configuration, the speaker frame and/or one or more other internal components of the speaker are coated with a Teflon material that inhibits or prevents the speaker cone from sticking to the speaker frame and/or one or more other internal components of the speaker when the speaker insert is exposed to a vacuum; however, this is not required.

In yet another and/or alternative non-limiting aspect of the present invention, a frame portion of the speaker that faces the inner surface or underside of the speaker cone has a shape and/or spacing from the inner surface or underside of the speaker cone that a) inhibits the inner surface or underside of the speaker cone from sticking to one or more components of the speaker, b) inhibits or prevents one or more portions of the speaker cone from flipping inside-out, and/or c) inhibits or prevents one or more portions of the speaker cone to stick to or adhere to the speaker frame and/or one or more other components of the speaker. In one non-limiting embodiment of the invention, the speaker frame is formed into a shape so as to have an upper face that is similar in shape to the inner surface or underside of the speaker insert as discussed above and/or has a spacing from the inner surface or underside of the speaker cone that is similar in distance to the speaker insert as discussed above. As such, the speaker frame can be shaped to perform the same or similar function as the speaker insert discussed above, thereby partially or fully eliminating the need to use the speaker insert as discussed above. As can be appreciated, the shaping of the frame portion of the speaker as mentioned above can be such that the speaker insert is not required, and the shaping of the frame portion of the speaker is used to a) inhibit the inner surface or underside of the speaker cone from sticking to one or more components of the speaker, b) inhibit or prevent one or more portions of the speaker cone from flipping inside-out, and/or c) inhibit or prevent one or more portions of the speaker cone to stick to or adhere to the speaker frame and/or one or other components of the speaker.

One non-limiting object of the present invention is an improved speaker that can be used in a variety of environments.

Another and/or alternative non-limiting object of the present invention is an improved speaker that is designed to restrict movement of at least a portion of the speaker cone during and/or after a heat immersion process.

Still another and/or alternative non-limiting object of the present invention is an improved speaker that is designed to inhibit one or more portions of the speaker cone from at least partially flipping inside-out during and/or after a heat immersion process.

Yet another and/or alternative non-limiting object of the present invention is an improved speaker that is designed to inhibit the speaker cone from sticking to one or more components of the speaker during and/or after a heat immersion process.

Still yet another and/or alternative non-limiting object of the present invention is an improved speaker that is designed to restrict movement of at least a portion of the speaker cone when exposed to a vacuum.

Another and/or alternative non-limiting object of the present invention is an improved speaker that is designed to inhibit one or more portions of the speaker cone from at least partially flipping inside-out when exposed to a vacuum.

Still another and/or alternative non-limiting object of the present invention is an improved speaker that is designed to inhibit the speaker cone from sticking to one or more components of the speaker when exposed to a vacuum.

Yet another and/or alternative non-limiting object of the present invention is an improved speaker that is designed to support a speaker cone in a profile that does not cause the speaker cone to undesirably deform and/or be damaged when the speaker cone is subjected to pressure and/or heat.

Still yet another and/or alternative non-limiting object of the present invention is an improved speaker that includes a speaker insert that is designed to reduce desired stresses, damage, deformation and/or sticking of the speaker cone to the speaker insert and/or to a component of the speaker when subjected to heat and/or a vacuum.

Another and/or alternative non-limiting object of the present invention is an improved speaker that includes a speaker insert that is formed of and/or coated with a low stick or non-stick material that is designed to reduce or prevent sticking of the speaker cone to the speaker insert when subjected to heat and/or a vacuum.

Still another and/or alternative non-limiting object of the present invention is an improved speaker that includes a speaker frame that is designed to reduce desired stresses, damage, deformation and/or sticking of the speaker cone to the speaker frame and/or to a component of the speaker when subjected to heat and/or a vacuum.

Yet another and/or alternative non-limiting object of the present invention is an improved speaker that includes a speaker frame that is formed of and/or coated with a low stick or non-stick material that is designed to reduce or prevent sticking of the speaker cone to the speaker frame when subjected to heat and/or a vacuum.

These and other objects and advantages will become apparent to those skilled in the art upon the reading and following of this description taken together with the accompanying drawings.

### BRIEF DESCRIPTION OF THE DRAWINGS

Reference may now be made to the drawings, which illustrate non-limiting embodiments of the present invention;

FIG. 1 is a cut away elevation view of a prior art speaker;

FIG. 2 is a cut away elevation view of a speaker that includes a speaker insert in accordance with the present invention;

FIG. 3 is an elevation view of one non-limiting embodiment of a speaker insert in accordance with the present invention;

FIG. 4 is a cross-sectional view along line 4-4 of FIG. 3;

FIG. 5 is an elevation view of another non-limiting embodiment of a speaker insert in accordance with the present invention;

FIG. 6 is a cut away front elevation view of a speaker that includes a speaker insert of FIG. 5 in accordance with the present invention;

FIG. 7 is a cut away front elevation view of a speaker that includes a non-stick coating in accordance with the present invention;

FIG. 8 is a cut away front elevation view of a speaker that includes a speaker insert of FIG. 5 in accordance with the present invention wherein the speaker insert and the speaker includes a non-stick coating; and,

FIG. 9 is a cut away front elevation view of a speaker that includes a modified speaker frame in accordance with the present invention.

### DETAILED DESCRIPTION OF THE INVENTION

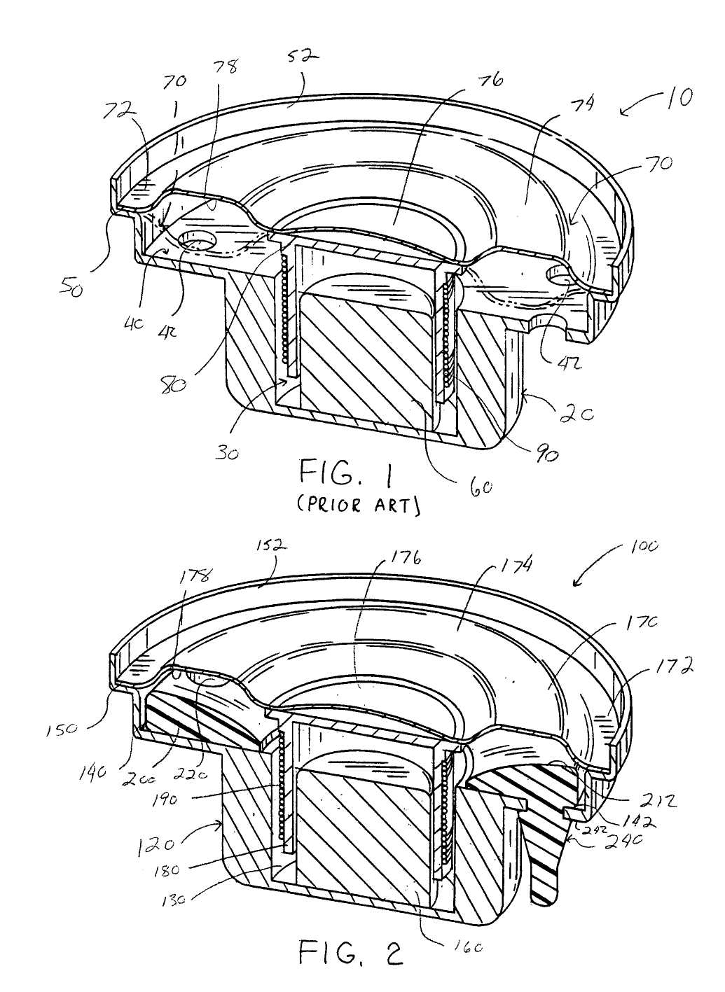

Referring now to the drawings which illustrate non-limiting embodiments of the present invention, FIG. 1 illustrates a prior art speaker 10. Speaker 10 includes a speaker frame 20 that includes a magnet cavity 30, an upper face 40, and a cone ledge 50 that is elevated above the upper face. A peripheral rim 52 is positioned about the outer peripheral edge of the cone ledge. A plurality of air openings 42 are located in upper surface 40. The speaker frame is generally formed of a durable material such as metal, plastic, etc.; however, other or additional materials can be used. Positioned in magnet cavity 30 is a magnet 60. Generally diaphragm 80 is positioned about magnet 60. Positioned about diaphragm 80 is a speaker coil 90. A speaker cone 70 includes a peripheral edge 72 that is secured to cone ledge 50 of the speaker frame. The speaker cone includes a generally concave shape portion 74 and a generally flat or planar or slightly concave central portion 76. As can be appreciated, the speaker cone can have many other profiles. The bottom surface 78 of the speaker cone is secure to the top of the diaphragm 80. Generally an adhesive is used to form the connection, however, other or additional connection arrangements can be used. The materials used to form the speaker cone and other components of the speaker are well known in the art, thus will not be described herein. In addition, the normal operation of speaker 10 is also well known in the art, thus will also not be described herein.

Speaker 10 is typically a type of speaker that can be used in emergency equipment, such as firefighting equipment. Such speakers are required to be tested by a heat immersion test. During the heat immersion test, the speaker cone can flip inside-out as illustrated by the dotted line in FIG. 1. When the speaker cone flips inside-out, the speaker cone can be damaged, thus interfering with the proper operation of the speaker. In addition, when the speaker cone is in an inverted or flipped inside-out position, the speaker either does not operate or operates at a very low sound quality. As such, in actual fire fighting situations, the inversion or flipping inside-out of the speaker cone can result in the communication system for the emergency equipment being fully or partially disabled. The speaker of the present invention overcomes this problem with prior art speakers.

Referring now to FIGS. 2-4, there is illustrated a speaker 100 in accordance with the present invention. The basic arrangement of speaker 100 is the same as speaker 10. Speaker 100 includes a speaker frame 120 that includes a magnet cavity 130, an upper face 140, a cone ledge 150, and a peripheral rim 152. A plurality of air openings 142 are located in upper surface 140. Positioned in magnet cavity 130 is a magnet 160. Generally, diaphragm 180 is positioned about magnet 160. Positioned about diaphragm 180 is a speaker coil 190. A speaker cone 170 includes a peripheral edge 172 that is secured to cone ledge 150 of the speaker frame. The speaker cone includes a generally concave shape portion 174 and a generally flat or planar or slightly concave central portion 176. The bottom surface 178 of the speaker cone is secure to the top of the diaphragm 180.

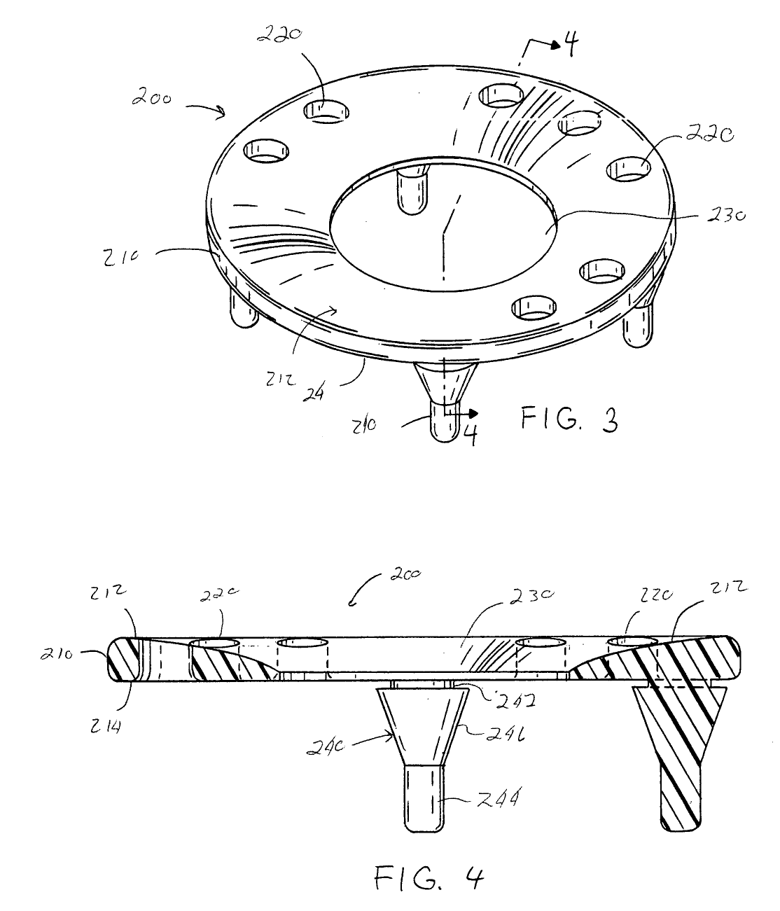

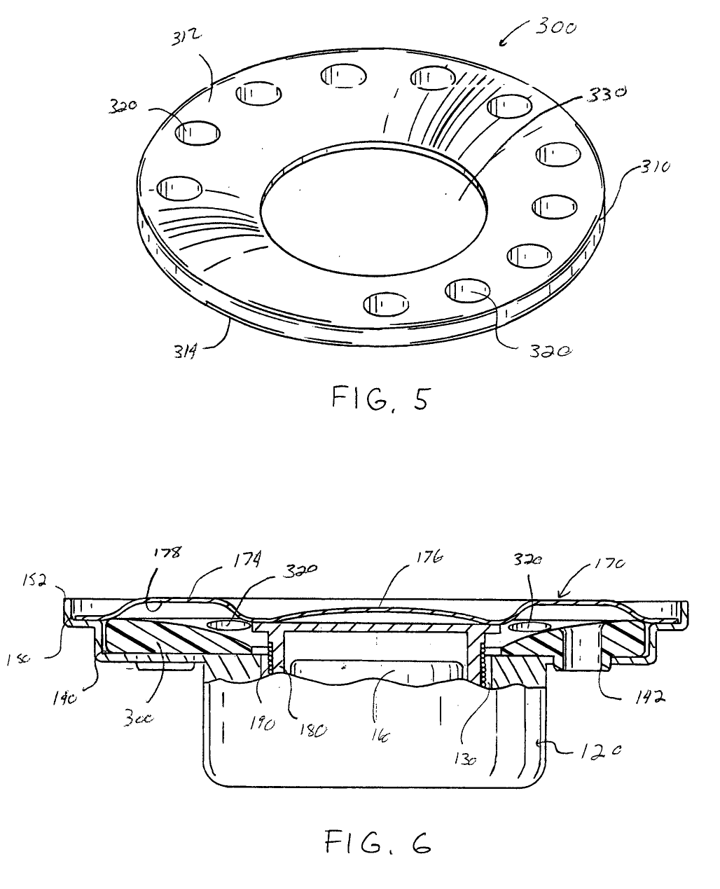

A speaker insert 200 is positioned between the speaker cone and speaker frame. As best illustrated in FIGS. 3 and 4, speaker insert 200 includes a body 210 having an upper face 212 and a lower face 214. The body has a cross-sectional shape and size so that the speaker insert completely fit in the speaker frame. Generally the speaker insert fits in the speaker frame such that the upper face of the speaker insert is positioned no higher and generally below the cone ledge 150. The body of the speaker insert is generally made of a durable material that can resist compression when the speaker cone, when exposed to a vacuum, collapses onto the speaker insert. Many types of materials can be used to partially or fully form the body of the speaker insert (e.g., nylon, silicon, plastic, etc.). Positioned through the top face of the body are a plurality of gas openings 220. The shape of the gas openings are generally circular and have generally the same cross-sectional area; however, this is not required. The gas openings enable gas (i.e., air) to flow into and out of the region between the speaker insert and the speaker cone. The flow of air facilitate in maintaining the sound quality of the speaker. Positioned in the central region of the speaker insert is a frame opening 230. The opening is shown to be generally circular; however, this is not required. The cross-section area of the frame opening is generally larger than each of the gas openings; however, this is not required. The frame opening is shaped and sized to enable diaphragm 180 to move relative to magnet 160 during the operation of speaker 100.

As illustrated in FIG. 4, the lower face 214 is generally flat and lies in substantially the same plane; however, this is not required. The upper face 212 has a sloped surface that slopes downwardly between the outer peripheral edge of the speaker inert and the frame opening. The angle of slope can vary or be constant. The sloping profile of the upper face is selected to be generally similar to the sloping profile of the bottom surface 178 of the speaker cone as illustrated in FIG. 2 to as to enable the speaker cone to vibrate during normal operation of the speaker. As is readily apparent from FIG. 6, the sloping profile of the speaker insert and the bottom surface 178 of the speaker cone do not have to be the same. Generally, the sloping profile of the speaker insert is selected such that the speaker insert does not connect to the bottom surface of the speaker cone during normal operation of the speaker; however, this is not required. As such, the size and profile of the speaker insert is generally selected such that during operation of the speaker during normal conditions, the speaker cone does not contact the speaker insert. The bottom face 214 of the speaker insert can include one or more legs 240. The legs are designed to be partially fitted through an air opening 142 so as to secure the speaker insert to the speaker frame. The legs can include a lock slot 242 that is designed to connect the leg in the air opening; however, this is not required. The bottom end 244 of the legs can be shaped and sized to facilitate in inserting the bottom end through an opening; however, this is not required. The legs are illustrated as having a fluted middle portion 246; however, it can be appreciated that many other shapes can be used. As can be appreciated, the speaker can be secured to the speaker frame by use of additional connection arrangements (e.g., adhesive, friction connection, melted connection, clamp, etc.); however, this is not required.

The position of the legs on the bottom surface of the speaker insert is generally selected to match a plurality of air openings in the speaker frame. The gas openings in the speaker insert may also match the position on one or more air openings in the speaker frame when the speaker insert is connected to the speaker frame; however, this is not required. The upper face of the speaker insert can be formed of and/or include a coating that creates a non-stick or reduced sticking surface; however, this is not required.

One non-limiting function of speaker insert 100 will now be described. In extreme environments such as environments that have large temperature and/or pressure changes, the speaker cone can collapse onto the speaker frame, thereby impairing and/or disabling the operation of the speaker. As illustrated in FIG. 1, the dotted line illustrates a collapsed speaker cone. The collapsing speaker cone is generally caused by a vacuum forming between the frame and the speaker cone. The deformation or collapse of the speaker cone can result in permanent deformation and/or result in damage to the speaker cone, which permanent deformation and/or speaker cone damage can adversely affect the sound output of the speaker. In addition, or alternatively, the deformation or collapse of the speaker cone can result in the underside or bottom surface of the speaker cone to potentially adhere to the speaker frame, thereby preventing the speaker cone from reverting back to its original shape. This sticking of the speaker cone to the speaker frame generally results from 1) adhesive on the speaker cone and/or speaker frame sticking to the speaker frame and/or speaker cone, and/or cohesion; however, sticking can be the result of other or additional reasons.

The problems associated with the collapsing of the speaker cone and/or the sticking of the speaker cone to the speaker frame can be inhibited or prevented by use of speaker insert 200. As illustrated in FIG. 2, the speaker insert has a shape and size such that when the speaker insert is secured to the speaker frame, the space between the top surface of the speaker insert and the bottom surface of the speaker cone is reduced so as to reduce the amount or degree of collapse of the speaker cone when exposed to a vacuum. The spacing between the speaker cone and the speaker insert can be selected to control the amount or degree to which the speaker cone can collapse when exposed to a vacuum and thereby minimize or prevent damage to the speaker cone. The spacing can also be selected to prevent the speaker cone from flipping inside-out. The material used to form the speaker insert or surface of the speaker insert can be selected to minimize the incidence of adhesion and/or cohesion between the speaker insert and speaker cone when the speaker cone is exposed to a vacuum. Referring now to FIGS. 5 and 6, there is illustrated another embodiment of the speaker insert. In this embodiment, speaker insert 300 is very similar to speaker insert 200 except that speaker insert 300 does not include any legs. A speaker insert 300 includes a body 310 having an upper face 312 and a lower face 314. The body has a cross-sectional shape and size so that the speaker insert completely fits in the speaker frame. Generally, the speaker insert fits in the speaker frame such that the upper face of the speaker insert is positioned no higher and generally below the cone ledge 150 as illustrated in FIG. 6. Positioned through the top face of the body are a plurality of gas openings 320. The shape of the gas openings are generally circular and have generally the same cross-sectional area; however, this is not required. Positioned in the central region of the speaker insert is a frame opening 330. The opening is shown to be generally circular; however, this is not required. The cross-section area of the frame opening is generally larger than each of the gas openings; however, this is not required. The frame opening is shaped and sized to enable diaphragm 180 to move relative to magnet 160 during the operation of speaker 100 as illustrated in FIG. 6. As illustrated in FIG. 6, the lower face 314 is generally flat and lies in substantially the same plane; however, this is not required. The upper face 312 has a sloped surface that slopes downwardly between the outer peripheral edge of the speaker insert and the frame opening. The angle of slope can vary or be constant. The sloping profile of the upper face is selected to be generally similar to the sloping profile of the bottom surface 178 of the speaker cone as illustrated in FIG. 6 so as to enable the speaker cone to vibrate during normal operation of the speaker. As is readily apparent from FIG. 6, the sloping profile of the speaker insert and the bottom surface 178 of the speaker cone do not have to be the same. Generally, the sloping profile of the speaker insert is selected such that the speaker insert does not connect the bottom surface of the speaker cone during normal operation of the speaker; however, this is not required. As such, the size and profile of the speaker insert is generally selected such that during operation of the speaker during normal conditions, the speaker cone does not contact the speaker insert. The speaker insert is generally secured to the speaker frame by use of an adhesive; however, it will be appreciated that other or additional connection arrangements can be used to secure the speaker insert to the speaker frame (e.g., friction connection, melted connection, clamp, etc.).

The materials of the speaker insert, the positioning of the speaker insert 300 in the speaker frame, and the operation of speaker insert 300 in the speaker are the same or similar as speaker insert 200 as described above, thus the use and operation of the speaker insert 300 will not be repeated herein.

Referring now to FIG. 8, a modification of the speaker insert 300 is illustrated. Speaker insert 300 includes a low stick or non-stick coating 340 on the upper surface 312 of the speaker insert. Non-limiting examples of low stick or non-stick coatings that can be at least partially coated on the speaker insert include, but are not limited to, silicone compounds, fluoropolymer coatings (e.g., Teflon coatings, etc.). The low stick or non-stick coating on the speaker insert facilitates in enabling the speaker insert to resist sticking to the speaker cone. An adhesive is commonly located on the inner surface or underside of the speaker cone which can soften and/or melt during extreme conditions. The softened or melted adhesive can come in contact with the speaker insert when the speaker cone collapses on the speaker insert. The contact of the adhesive on the speaker cone to the speaker insert can result in the speaker cone sticking to the speaker insert. The speaker cone can also or alternatively adhere to the speaker insert by cohesion. The sticking of the speaker cone to the speaker insert can significantly impair the operation of the speaker. The use of a low stick or non-stick coating in the speaker insert can be used to inhibit or prevent sticking of the speaker cone to the speaker insert.

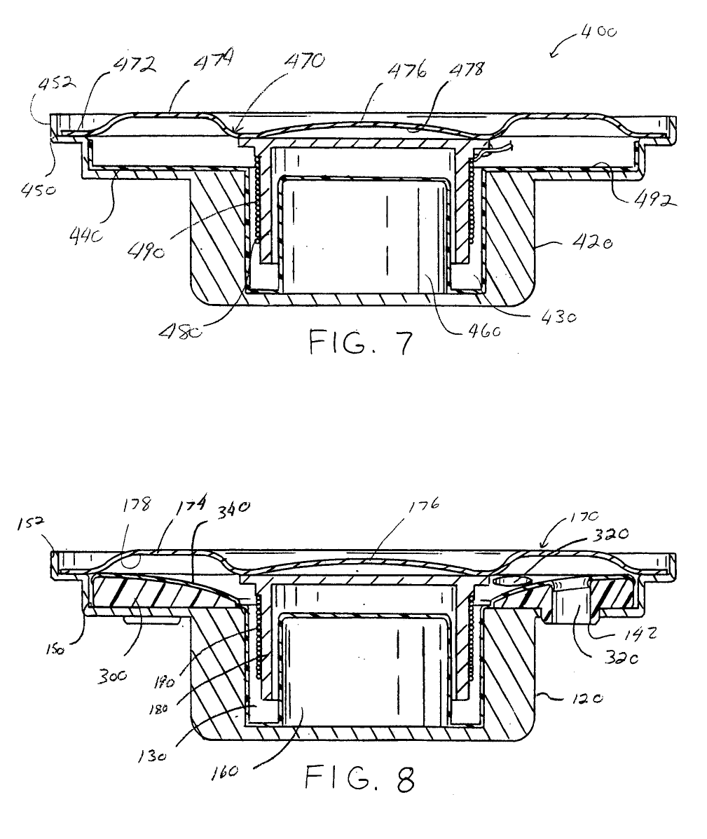

Referring now to FIG. 7, another embodiment of the invention is disclosed. In this embodiment, a speaker 400 is disclosed. The basic arrangement of speaker 400 is the same as speaker 10. Speaker 400 includes a speaker frame 420 that includes a magnet cavity 430, an upper face 440, a cone ledge 450, and a peripheral rim 452. A plurality of air openings, not shown, are located in upper surface 440. Positioned in magnet cavity 430 is a magnet 460. Generally diaphragm 480 is positioned about magnet 460. Positioned about diaphragm 480 is a speaker coil 490. A speaker cone 470 includes a peripheral edge 472 that is secured to cone ledge 450 of the speaker frame. The speaker cone includes a generally concave shaped portion 474 and a generally flat or planar or slightly concave central portion 476. The bottom surface 478 of the speaker cone is secure to the top of the diaphragm 480.

The upper face 440 of the speaker frame includes a low stick or non-stick coating 492. The low stick or non-stick coating 492 can be also located on other regions of the speaker frame (e.g., magnet cavity, cone ledge, magnet, etc.); however, this is not required. Non-limiting examples of low stick or non-stick coatings that can be at least partially coated on one or more regions of the speaker frame include, but are not limited to, silicone compounds, fluoropolymer coatings (e.g., Teflon coatings, etc.). The low stick or non-stick coating on the speaker frame facilitates in enabling the speaker frame to resist sticking to the speaker cone. As mentioned above, an adhesive is commonly located on the inner surface or underside of the speaker cone which can soften and/or melt during extreme conditions. The softened or melted adhesive can come in contact with the speaker frame when the speaker cone collapses on the speaker insert. The contact of the adhesive on the speaker cone on the speaker frame can result in the speaker cone sticking to the speaker frame. The speaker cone can also or alternatively adhere to the speaker frame by cohesion. The sticking of the speaker cone to the speaker frame can significantly impair the operation of the speaker. The use of a low stick or non-stick coating on the speaker frame can be used to inhibit or prevent sticking of the speaker cone to the speaker frame.

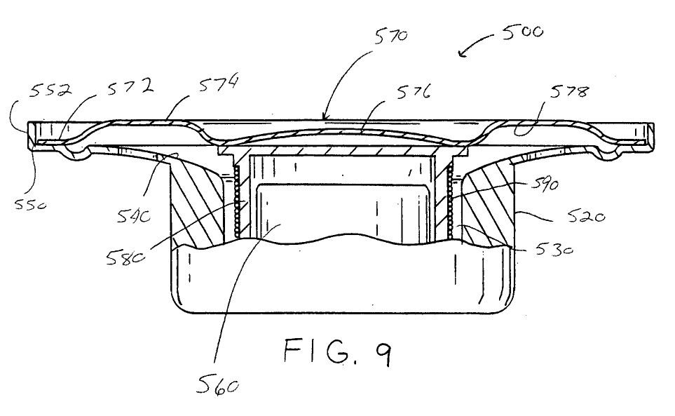

Referring now to FIG. 9, another embodiment of the invention is disclosed. In this embodiment, a speaker 500 is disclosed. The basic arrangement of speaker 500 is the same as speaker 10. Speaker 500 includes a speaker frame 520 that includes a magnet cavity 530, an upper face 540, a cone ledge 550, and a peripheral rim 552. A plurality of air openings, not shown, are located in upper surface 540. Positioned in magnet cavity 530 is a magnet 560. Generally, diaphragm 580 is positioned about magnet 560. Positioned about diaphragm 580 is a speaker coil 590. A speaker cone 570 includes a peripheral edge 572 that is secured to cone ledge 550 of the speaker frame. The speaker cone includes a generally concave shaped portion 574 and a generally flat or planar or slightly concave central portion 576. The bottom surface 578 of the speaker cone is secured to the top of the diaphragm 580.

The upper surface 540 of the speaker frame in FIG. 9 is different from the upper surface 40 of the speaker frame in FIG. 1 in that upper surface 540 has a sloping profile that generally follows the bottom surface profile of the speaker cone. In essence, the profile of upper surface 540 is the same or similar to the profile created by the upper surface of the speaker insert as illustrated in FIGS. 2, 6, and 8. The upper surface 540 has a sloped surface that slopes downwardly between the cone ledge 550 and the magnet cavity 530. The angle of slope can vary or be constant. The sloping profile of the upper surface is selected to be generally similar to the sloping profile of the bottom surface 578 of the speaker cone as illustrated in FIG. 9 to as to enable the speaker cone to vibrate during normal operation of the speaker. As is readily apparent from FIG. 9, the sloping profile of the upper surface of the speaker frame and the bottom surface 578 of the speaker cone do not have to be the same. Generally, the sloping profile of the upper surface of the speaker frame is selected such that the upper surface of the speaker frame does not connect the bottom surface of the speaker cone during normal operation of the speaker; however, this is not required. As such, the profile of the upper surface of the speaker frame is generally selected such that during operation of the speaker during normal conditions, the speaker cone does not contact the upper surface of the speaker frame.

Although not shown, the upper face 540 of the speaker frame can include a low stick or non-stick coating. The use of such a low stick or non-stick coating on one or more portions of the speaker frame was described above with reference to speaker 400 that is illustrated in FIG. 7. The low stick or non-stick coating, when used, can be also located on other regions of the speaker frame (e.g., magnet cavity, cone ledge, magnet, etc.); however, this is not required. Non-limiting examples of low stick or non-stick coatings that can be at least partially coated on one or more regions of the speaker frame include, but are not limited to, silicone compounds, fluoropolymer coatings (e.g., Teflon coatings, etc.). The low stick or non-stick coating on the speaker frame facilitates in enabling the speaker frame to resist sticking to the speaker cone. The use of a low stick or non-stick coating on the speaker frame can be used to inhibit or prevent sticking of the speaker cone to the speaker frame. As can be appreciated, a low stick or non-stick coating can be additionally or alternatively be applied to the bottom surface of the cone so as to inhibit or prevent sticking of the speaker cone to the speaker frame.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings will be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

We claim:

1. A speaker insert designed to be inserted at least partially between a frame and a speaker cone of a speaker, said speaker insert comprising a body having a front face and a rear face, a frame opening positioned at least closely adjacent to a center region of said body, and a plurality of gas openings spaced from said frame opening and spaced from a peripheral edge of said body, said frame opening having a cross-sectional area that is greater than a cross-sectional area of each of said gas openings, said frame opening and at least one of said gas openings passing completely through said body.

2. The speaker insert as defined in claim 1, wherein said front face of said body has a generally concave profile.

3. The speaker insert as defined in claim 2, wherein said concave profile on said front face has an average slope angle of about 1-50°.

4. The speaker insert as defined in claims 1-3, wherein said peripheral edge of said speaker insert has a thickness that is greater than a thickness of said center region of said speaker insert.

5. The speaker insert as defined in claims 1-4, wherein a size ratio of said cross-sectional area of said front opening to said cross-sectional area of each of said gas openings is about 2-100:1.

6. The speaker insert as defined in claims 1-5, wherein a plurality of said gas openings are spaced an equal distance from said primary opening.

7. The speaker insert as defined in claims 1-6, wherein at least three of said gas openings are spaced equal distances from one another.

8. The speaker insert as defined in claims 1-7, wherein said rear face has a generally planar profile.

9. The speaker insert as defined in claims 1-8, including a plurality of speaker legs secured to said rear face.

10. The speaker insert as defined in claim 9, wherein at least three legs are spaced at an equal distance from one another.

11. The speaker insert as defined in claim 9 or 10, wherein at least one of said speaker legs includes a connector, said connector including a structure selected from the group consisting of a slot, barb, flange, landing, or combinations thereof.

12. The speaker insert as defined in claims 1-11, wherein said body includes a rounded outer edge.

13. The speaker insert as defined in claims 1-12, wherein said front face is at least partially formed of nylon, silicone, or combinations thereof.

14. The speaker insert as defined in claims 1-13, wherein said front face is at least partially coated with a low stick or non-stick material.

15. A speaker designed to limit damage to a speaker cone comprising a speaker frame, and a speaker insert, said speaker cone at least partially secured to said speaker frame, said speaker insert at least partially positioned between said speaker frame and said speaker cone, said speaker insert mounted to said speaker frame so as to maintain a spaced relationship between said speaker insert and at least a majority of said speaker cone during operation of said speaker in an ambient temperature and pressure, said speaker insert spaced a distance from an underside of said speaker cone so as to inhibit the speaker cone from at least partially flipping inside out when a vacuum forms between said speaker cone and said speaker frame.

16. The speaker as defined in claim 15, wherein said speaker frame maintains a spaced relationship between said speaker insert and all of said speaker cone during operation of said speaker in an ambient temperature and pressure.

17. The speaker as defined in claim 15 or 16, wherein said speaker insert includes a body having a front face and a rear face, a frame opening positioned at least closely adjacent to a center region of said body, and a plurality of gas openings spaced from said frame opening and spaced from a peripheral edge of said body, said frame opening having a cross-sectional area that is greater than a cross-sectional area of each of said gas openings, said frame opening and at least one of said gas openings passing completely through said body.

18. The speaker as defined in claims 15-17, wherein said underside of said speaker cone has a generally concave profile, said speaker insert having a top surface that has a generally concave profile.

19. The speaker as defined in claim 18, wherein said corresponding concave profile of said top surface of said speaker insert and said underside of said speaker cone are generally the same.

20. The speaker as defined in claims 15-19, wherein said peripheral edge of said speaker insert has a thickness that is greater than a thickness of said center region of said speaker insert.

21. The speaker as defined in claims 17-20, wherein a size ratio of said cross-sectional area of said front opening to said cross-sectional area of each of said gas openings is about 2-100:1.

22. The speaker as defined in claims 17-21, wherein a plurality of said gas openings are spaced an equal distance from said primary opening.

23. The speaker as defined in claims 17-22, wherein at least three of said gas openings are spaced equal distances fro one another.

24. The speaker as defined in claims 15-23, wherein said rear face of said speaker insert has a generally planar profile.

25. The speaker as defined in claims 15-24, wherein said speaker insert includes a plurality of speaker legs secured to said rear face.

26. The speaker as defined in claim 25, wherein at least three legs are spaced at an equal distance from one another.

27. The speaker as defined in claim 25 or 26, wherein at least one of said speaker legs includes a connector, said connector including a structure selected from the group consisting of a slot, barb, flange, landing, or combinations thereof.

28. The speaker as defined in claims 15-27, wherein said body includes a rounded outer edge.

29. The speaker as defined in claims 15-28, wherein said front face is at least partially formed of nylon, silicone, or combinations thereof.

30. The speaker as defined in claims 15-29, wherein said front face of said speaker insert is at least partially coated with a low stick or non-stick material.

31. The speaker as defined in claims 15-30, wherein at least a portion of said speaker frame is coated with a low stick or non-stick material.

32. A speaker designed to limit damage to a speaker cone comprising a speaker frame that is secured to the speaker cone, said speaker frame having a spaced relationship from at least a majority of said speaker cone during operation of said speaker in an ambient temperature and pressure, said speaker frame spaced a distance from an underside of said speaker cone so as to inhibit the speaker cone from at least partially flipping inside out when a vacuum forms between said speaker cone and said speaker frame.

33. The speaker as defined in claim 32, wherein said underside of said speaker cone has a generally concave profile, said speaker frame having a top surface that has a generally concave profile.

34. The speaker as defined in claim 33, wherein said corresponding concave profile of said top surface of said speaker frame and said underside of said speaker cone are generally the same.

35. The speaker as defined in claims 32-34, wherein said front face of said speaker frame is at least partially coated with a low stick or non-stick material.
